(19) United States
(12) Patent Application Publication
(10) Pub. No.: US 2011/0090840 A1
(43) Pub. Date: Apr. 21, 2011

(54) COMMUNICATION SYSTEM FOR REMOVING TRANSMISSION OVERHEAD

(75) Inventors: Kyoung Seok Lee, Daejeon (KR); Jae Young Ahn, Daejeon (KR); Jae Heung Kim, Daejeon (KR); Yeong Jin Kim, Daejeon (KR)

(73) Assignee: Electronics and Telecommunications Research Institute, Daejeon (KR)

(21) Appl. No.: 12/996,931

(22) PCT Filed: Jul. 17, 2009
(86) PCT No.: PCT/KR09/03947

§ 371 Date: Dec. 8, 2010

(30) Foreign Application Priority Data
Jul. 21, 2008 (KR) 10-2008-0070692
Jul. 9, 2009 (KR) 10-2009-0062691

(51) Int. Cl. H04B 7/14

(52) U.S. Cl. 370/315

(57) ABSTRACT

Provided is a technology that may decrease or eliminate communication overhead in a communication system including a relay. A base station included in the communication system may compress a protocol header to transmit data. The relay may receive the compressed protocol header and the data, and then decompress the compressed protocol header to transmit the decompressed protocol header to a terminal.

### TECHNICAL FIELD

The present invention relates to a technology that may decrease communication overhead in a communication system including a relay.

### BACKGROUND ART

3^{rd} Generation Partnership Project (3GPP) that is a mobile communication standardization organization is engaging in a Long Term Evolution (LTE) standardization process in order to develop standardized next generation mobile communication systems. Also, LTE-advanced standardization development for supplementing an LTE standard is currently under way in order to satisfy an International Mobile Telecommunication (IMT)-advanced system requirement that is required in International Telecommunication Union (ITU)-R.

A mobile communication system generally includes a user terminal and a base station constituting a cell. In the mobile communication system, a plurality of terminals may transmit and receive packet data to and from the base station via a radio channel. In order to expand a communication coverage of the base station or to enhance a communication capacity of the base station, a scheme of wirelessly connecting the base station and a relay to enable the relay to relay communication signals between the terminal and the base station is being adopted. The relay may perform a radio communication relay by receiving data via a radio channel, used in the mobile communication system, to transmit the received data via the radio channel. When the base station is wirelessly connected to a gateway of a heterogeneous communication network to thereby relay data, the base station may be defined as the relay.

### DISCLOSURE OF INVENTION

### Technical Problem

An aspect of the present invention provides a technology that may decrease an amount of control information used to transmit data.

Another aspect of the present invention also provides a technology that may enhance a data transmission efficiency.

### Technical Solution

According to an aspect of the present invention, there is provided a base station including: a receiver to receive a General Packet Radio Service (GPRS) Tunneling Protocol (GTP) header and a data packet from a gateway; a header compression unit to compress the GTP header; and a transmitter to transmit the compressed GTP header and the data packet to a relay.

According to another aspect of the present invention, there is provided a relay including: a receiver to receive a data packet and a compressed GTP header from a base station; a header decompression unit to decompress the compressed GTP header; and a transmitter to transmit the data to a terminal using the decompressed GTP header.

According to still another aspect of the present invention, there is provided a gateway including: a header compression unit to compress an IP header associated with data and a UDP/Real-time Transport Protocol (RTP) header associated with the data; and a transmitter to transmit the data, the compressed IP header, and the compressed UDP/RTP header to a base station. The base station may forward the data, the compressed IP header, and the compressed UDP/RTP header to a relay.

### Advantageous Effects

According to embodiments of the present invention, it is possible to decrease an amount of control information used to transmit data.

### BRIEF DESCRIPTION OF DRAWINGS

FIG. 1 is a diagram illustrating a configuration of a packet-based mobile communication system to transmit data using a relay according to an embodiment of the present invention;

FIG. 2 is a diagram illustrating a structure of a data plane protocol according to an embodiment of the present invention;

FIG. 3 is a diagram illustrating a format of a downlink packet where a header is compressed according to an embodiment of the present invention;

FIG. 4 is a diagram illustrating a format of a downlink packet where a plurality of data packets are integrated according to an embodiment of the present invention;

FIG. 5 is a block diagram illustrating a structure of a relay according to an embodiment of the present invention;

FIG. 6 is a block diagram illustrating a structure of a gateway according to an embodiment of the present invention; and

FIG. 7 is a block diagram illustrating a structure of a base station according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

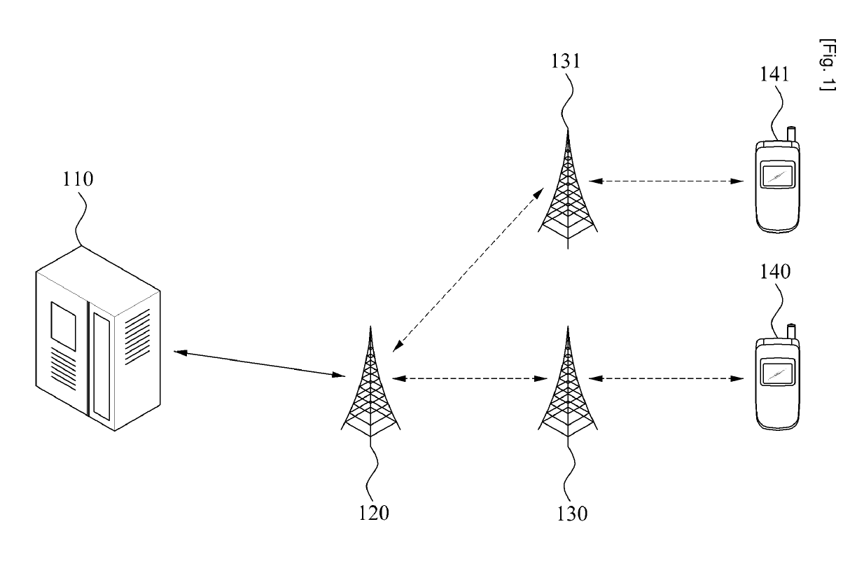

FIG. 1 is a diagram illustrating a configuration of a packet-based mobile communication system to transmit data using a relay according to an embodiment of the present invention.

Referring to FIG. 1, a gateway 110 may correspond to a contact point between an external network and a radio communication network including a base station 120, relays 130 and 131, and terminals 140 and 141. The gateway 110 may receive data that the terminals 140 and 141 transmit to the external network via the base station 120 and the relays 130 and 131. Also, the gateway 110 may transmit, to the terminals 140 and 141 via the base station 120 and the relays 130 and 131, data that is received from the external network.

The base station 120 may transmit data to the terminals 140 and 141. When the terminals 140 and 141 are located outside a coverage of the base station 120, the base station 120 may transmit the data to the terminals 140 and 141 via the relays 130 and 131.

The relays 130 and 131 may transmit, to the terminals 140 and 141 using a radio channel, first data that is received from the base station 120. Also, the relays 130 and 131 may transmit, to the base station 120, second data that is received from the terminals 140 and 141. According to an embodiment of the present invention, the relay 130 may transmit data to the base station 120 or the terminals 140 and 141 via another relay 131.

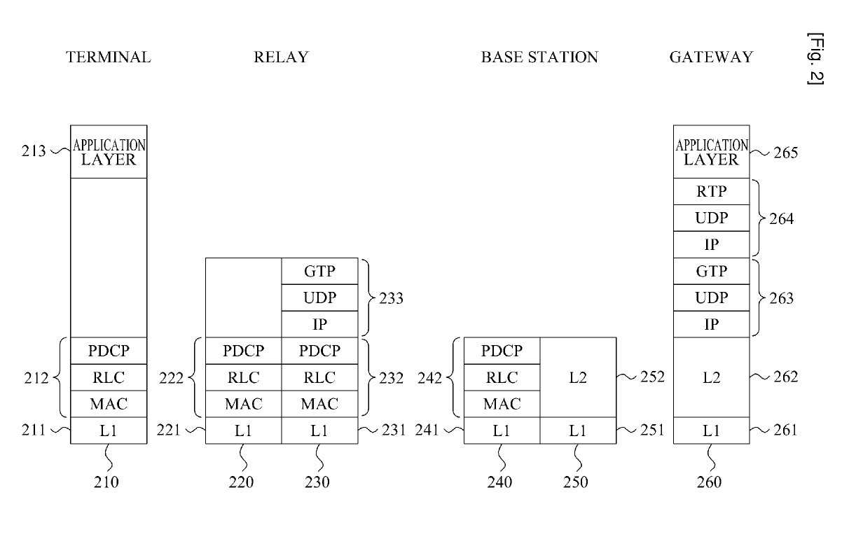

FIG. 2 is a diagram illustrating a structure of a data plane protocol according to an embodiment of the present invention. Hereinafter, although the structure of the data plane protocol is described based on a downlink from a gateway to a terminal, the gateway, a base station, and a relay according to an embodiment of the present invention may operate similarly even in an uplink.

A protocol stack 210 of the terminal may include a Layer (L1) 211, a Layer (L2) 212, and an application layer 213. A protocol stack 220 of the relay corresponding to the terminal may include a Layer (L1) 221 and a Layer (L2) 222 to transmit data to the terminal. A protocol stack 230 of the relay corresponding to the base station may include a Layer (L1) 231 and a Layer (L2) 232 to receive the data from the base station, and a layer 233 for a General Packet Radio Service (GPRS) Tunneling Protocol (GTP), an User Datagram Protocol (UDP), and an Internet Protocol (IP) of the relay.

A protocol stack 240 of the base station corresponding to the relay may include a Layer (L1) 241 and a Layer (L2) 242 to transmit the data to the relay. A protocol stack 250 of the base station corresponding to the gateway may include a Layer (L1) 251 and a Layer (L2) 252 to receive the data from the gateway. According to an embodiment of the present invention, the base station may not include a protocol stack corresponding to the layer 233 for the GTP, the UDP, and the IP of the relay.

A protocol stack 260 of the gateway may include a Layer (L1) 261 and a Layer (L2) 262. A layer 23 for a GTP, a UDP, and an IP of the gateway may correspond to the layer 233 for the GTP, the UDP, and the IP included in the protocol stack 230 of the relay. The protocol stack of the gateway 260 may include a layer 264 for a Real-time Transport Protocol (RTP), a UDP, and an IP, and an application layer 265.

Referring to FIG. 2, in order to transmit the data of the application layer 265, the gateway corresponding to a serving gateway (S-GW) may use the layer 264 for the IP, the UDP, and the RTP that are associated with the data. The gateway may use a GTP in order to transmit the data without exposing the data. Here, the GTP denotes a protocol that may operate based on the IP protocol. Therefore, IP session associated with GTP session and UDP session associated with the GTP session may exist. In this specification, an IP session associated with data, a UDP session associated with data, an RTP session associated with data, and the like to transmit data of an application layer may be classified into protocols associated with the data. Also, an IP session associated with GTP session, a UDP session associated with GTP session, and the like to operate the GTP session may be classified into protocols associated with the GTP session.

The gateway may be connected to the base station using a line, and may use the Layer 1 (L1) 261 and the Layer 2 (L2) 262 in order to transmit the data to the base station.

The base station may forward, to the relay, the data received from the gateway. Specifically, the base station may receive the data from the gateway using the Layer 1 (L1) 251 and the Layer 2 (L2) 252. The base station may transmit the data to the relay that is wirelessly connected to the base station, using the Layer (L1) 241 and the Layer (L2) 242 of a 3^{rd} Generation Partnership Project (3GPP) Long Term Evolution (LTE) protocol.

The relay may receive the data from the base station using the Layer (L1) 231 and the Layer (L2) 232 of a 3GPP LTE protocol. The relay may receive a protocol associated with the GTP from the gateway via the base station.

The relay may transmit the data to the terminal that is wirelessly connected to the relay, using the Layer (L1) 221 and the Layer (L2) 222 of a 3GPP LTE protocol.

The terminal may receive the data using the Layer (L1) 211 and the Layer (L2) 212 of a 3GPP LTE protocol, and transfer the data to the application layer 213.

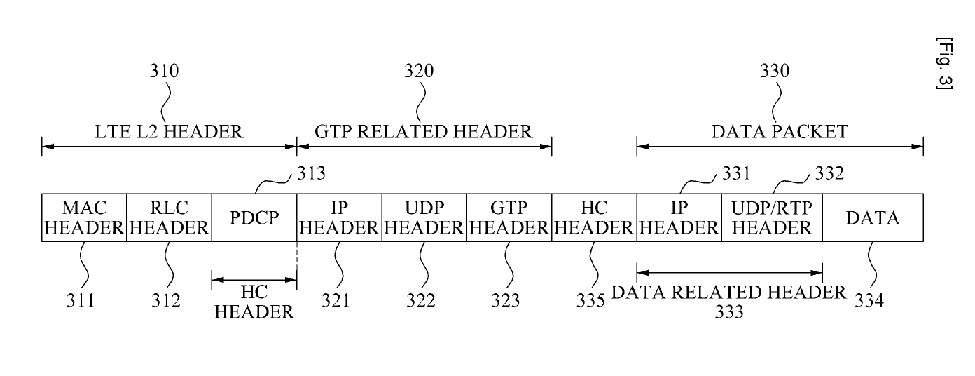

FIG. 3 is a diagram illustrating a format of a downlink packet where a header is compressed according to an embodiment of the present invention. A base station according to an embodiment of the present invention may transmit the downlink packet of FIG. 3 to a terminal via a relay.

Referring to FIG. 3, the downlink packet may include an LTE L2 header 310. The LTE L2 header 310 may include a Media Access Control (MAC) header 311 and a Radio Link Control (RLC) header 312. The base station may transmit data 334 to the terminal via the relay using a 3GPP LTE protocol.

The downlink packet may include a GTP related header 320. The GTP related header 320 may include a GTP header 323, an IP header 321 associated with the GTP header 323, and a UDP header 322 associated with the GTP header 323. Here, the IP header 321 and the UDP header 332 that are included in the GTP related header 320 may be used to operate the GTP, and thus are different from an IP header 331 associated with the data 334 and a UDP/RTP header 332 associated with the data 334.

According to an embodiment of the present invention, the base station may compress the GTP related header 320. When the GTP related header 320 is compressed, it may decrease an amount of control information used to transmit the data. Since overhead for transmitting the data decreases, it is possible to effectively use a radio channel. The base station may compress the GTP related header 320 using a RObust Header Compression (ROHC) scheme. The base station 320 may generate, as header decompression information, information to decompress the compressed GTP related header 320, and may insert the header decompression information into a Packet Data Convergence Protocol (PDCP) 313 of the LTE L2 header 310 as a header compression (HC) header 335.

The downlink packet may include a data packet 330. The data packet 330 may include the data 334, the IP header 331 associated with the data 334, and the UDP/RTP header 332 associated with the data 334.

According to an embodiment of the present invention, the gateway may compress a data related header 333. When the data related header 333 is compressed, it may decrease an amount of control information used to transmit the data 334. Therefore, it is possible to effectively use a radio channel. The gateway may generate, as header decompression information, information to decompress the data related header 333, and may insert the header decompression information as the HC header 335.

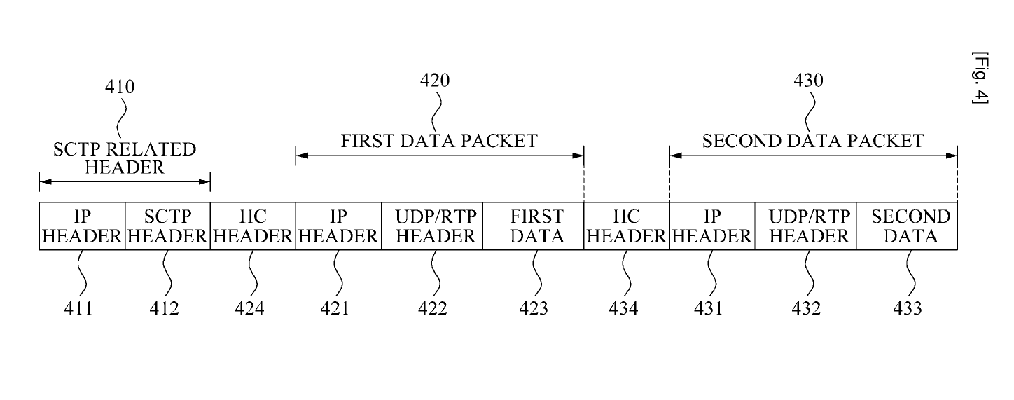

FIG. 4 is a diagram illustrating a format of a downlink packet where a plurality of data packets are integrated according to an embodiment of the present invention. When a gateway integrates a plurality of data packets and transmits the integrated data packet, it may decrease a data transmission amount and a number of data transmissions when a base station transmits data to a relay.

Referring to FIG. 4, a base station may receive a first data packet 420 and a second data packet 430 from the gateway. The first data packet 420 may include an IP header 421 associated with the first data 423, and an UDP/RTP header 422 associated with the first data 423. The second data packet 430 may include an IP header 431 associated with the second data 433, and an UDP/RTP header 432 associated with the second data 433.

The base station may generate, as a Stream Control Transport Protocol (SCTP) related header 410, information associated with the first data packet 420 and the second data packet 430. The SCTP related header 410 may include an IP header 411 and an SCTP header 412.

According to an embodiment of the present invention, the base station may compress headers associated with data that are included in each data packet, and thereby generate header decompression information, and insert the header decompression information as an HC header. For example, referring to FIG. 4, the base station may compress the IP header 421 and the UDP/RTP header 422 associated with the first data 423, included in the first data packet 420, and the IP header 431 and the UDP/RTP header 432 associated with the second data 433, included in the second data packet 430, and thereby generate the header decompression information. Next, the base station may insert the generated header information as HC headers 424 and 434.

According to an embodiment of the present invention, a number of data packets transmitted by the base station may decrease. Accordingly, a utilization rate of an SCTP related header and an L2 header may decrease. In particular, when transmitting a small amount of data such as a voice packet, a number of transmissions may also decrease.

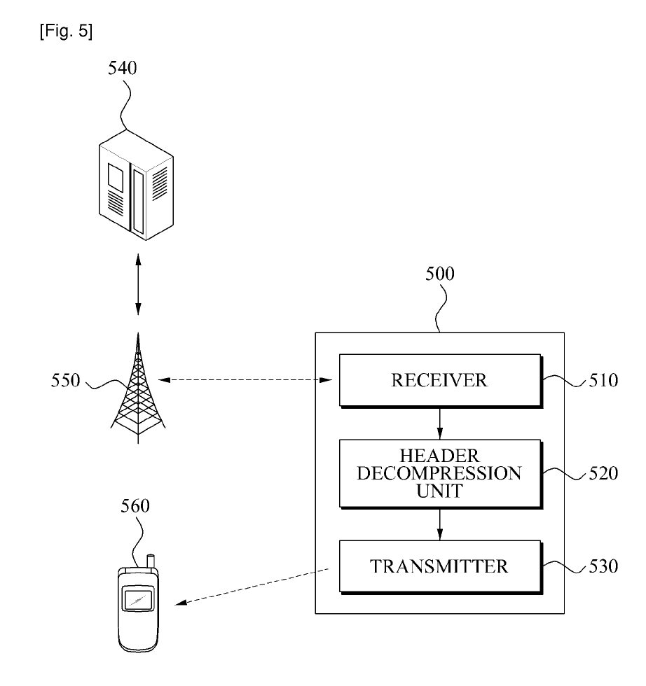

FIG. 5 is a block diagram illustrating a structure of a relay 500 according to an embodiment of the present invention. Referring to FIG. 5, the relay 500 may include a receiver 510, a header decompression unit 520, and a transmitter 530.

A gateway 540 may transmit data to the relay 500 via a base station 550. The gateway 540 may compress a GTP header associated with the data, and may transmit the GTP header to the relay 500 via the base station 550.

Also, the gateway 540 may transmit the GTP header associated with the data to the base station 550 without compressing the GTP header. The base station 550 may compress the GTP header and transmit the compressed GTP header to the relay 500.

The receiver 510 may receive the data and the compressed GTP header from the base station 550. According to an embodiment of the present invention, the gateway 540 or the base station 550 may compress the GTP header using a ROHC scheme.

The header decompression unit 520 may decompress the compressed GTP header. For example, the header decompression unit 520 may decompress the compressed GTP header using the ROHC scheme.

The receiver 510 may receive header decompression information from the base station 550, and decompress the compressed GTP header using the header decompression information.

The transmitter 530 may transmit the data to a terminal 560 using the decompressed GTP header.

The receiver 510 may additionally receive, from the base station 550, a compressed UDP header associated with the compressed GTP header and a compressed IP header associated with the compressed GTP header.

In this instance, the header decompression unit 520 may decompress the compressed UDP header and IP header. According to an embodiment of the present invention, the receiver 510 may additionally receive header decompression information to decompress the compressed UDP header and IP header that are associated with the compressed GTP header. The header decompression unit 520 may decompress the compressed UDP header and IP header using the header decompression information.

The transmitter 530 may transmit the data to the terminal 560 using the decompressed UDP header and IP header.

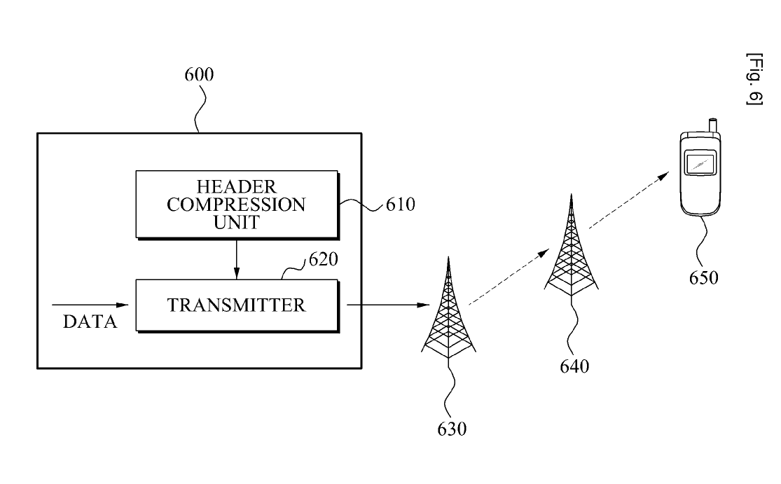

FIG. 6 is a block diagram illustrating a structure of a gateway 600 according to an embodiment of the present invention. Referring to FIG. 6, the gateway 600 may include a header compression unit 610 and a transmitter 620.

The header compression unit 610 may compress an IP header associated with data and a UDP/RTP header associated with the data. The header compression unit 610 may compress the IP header or the UDP/RTP header using a ROHC scheme.

The transmitter 620 may transmit the data, the compressed IP header, and the compressed UDP/RTP header to a base station 630. The base station 630 may forward the data, the compressed IP header, and the compressed UDP/RTP header to a relay 640 accessing the base station 630. The relay 640 may forward the data, the compressed IP header, and the compressed UDP/RTP header to a terminal 650 accessing the relay 640. The terminal 650 may decompress the compressed IP header and UDP/RTP header.

According to an embodiment of the present invention, the header compression unit 610 may generate header decompression information to decompress an IP associated with data or a UDP/RTP header associated with the data. The transmitter 620 may transmit the header decompression information to the terminal 650 via the base station 630 and the relay 640. The terminal 650 may decompress the IP header or the UDP/RTP header using the header decompression information.

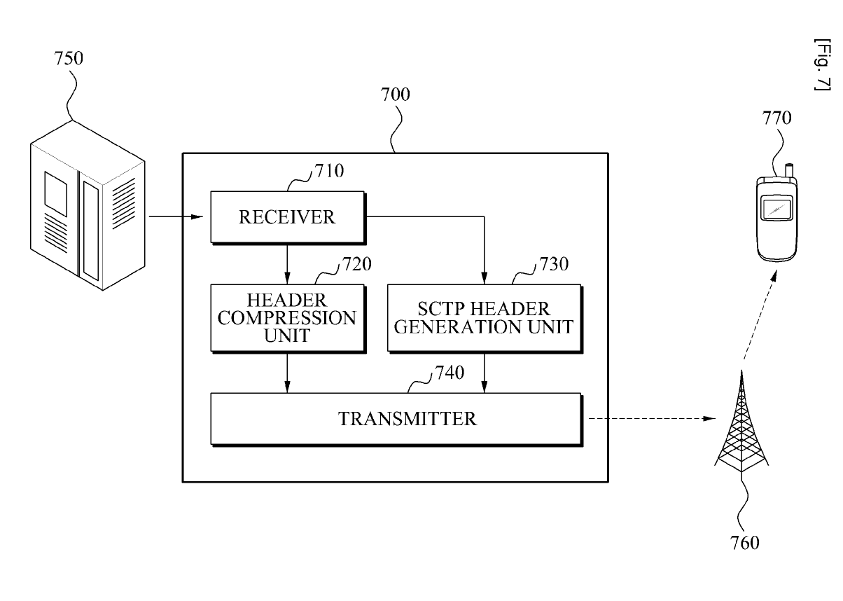

FIG. 7 is a block diagram illustrating a structure of a base station 700 according to an embodiment of the present invention. Referring to FIG. 7, the base station 700 may include a receiver 710, a header compression unit 720, an SCTP header generation unit 730, and a transmitter 740.

The receiver 710 may receive a GTP header and a data packet from a gateway 750. Here, a GTP denotes a protocol to transmit the data packet to an application without exposing contents of the data packet.

The header compression unit 720 may compress the GTP header. The header compression unit 720 may compress the GTP header using a ROHC scheme.

The transmitter 740 may transmit the compressed GTP header and the data packet to a relay 760. The relay 760 may transmit the data packet to a terminal 770.

Since the base station 700 compresses the GTP header, overhead for transmitting data may decrease. Accordingly, it is possible to effectively use a radio channel from the base station 700 to the relay 760, and a radio channel from the relay 760 to the terminal 770.

The header compression unit 720 may generate, as header decompression information, information to decompress the GTP header. The transmitter 740 may transmit the header decompression information to the terminal 770 via the relay 760.

The terminal 770 may decompress the compressed GTP header using the header decompression information.

The receiver 710 may additionally receive, from the gateway 750, a UDP header associated with the GTP header and an IP header associated with the GTP header. In this case, the header compression unit 720 may compress the UDP header and the IP header. The transmitter 740 may transmit the compressed UDP header and IP header to the terminal 770 via the relay 760.

The header compression unit 720 may generate, as header decompression information, information to decompress the UDP header associated with the GTP header, and information to decompress the IP header associated with the GTP header. The transmitter 740 may transmit the header decompression information to the transmitter 770 via the relay 760.

The terminal 770 may decompress the compressed UDP header and IP header using the header decompression information.

According to an embodiment of the present invention, the receiver 710 may receive a plurality of data packets from the gateway 750.

The SCTP header generation unit 730 may integrate the plurality of data packets and generate, as an SCTP header, information associated with the integrated data packet. The transmitter 740 may transmit the SCTP header and the integrated data packet to the relay 760.

According to an embodiment of the present invention, the relay 760 may separate the integrated data packet using the SCTP header, and sequentially transmit the separated data packets to the terminal 770.

According to another embodiment of the present invention, the relay 760 may transmit the SCTP header and the integrated data packet to the terminal 770. The terminal 770 may separate the integrated data packet using the SCTP header.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A base station comprising:
a receiver to receive a General Packet Radio Service (GPRS) Tunneling Protocol (GTP) header and a data packet from a gateway;
a header compression unit to compress the GTP header; and
a transmitter to transmit the compressed GTP header and the data packet to a relay.

2. The base station of claim 1, wherein the header compression unit compresses the GTP header using a RObust Header Compression (ROHC) scheme.

3. The base station of claim 1, wherein:
the header compression unit generates, as header decompression information, information to decompress the compressed GTP header,
the transmitter transmits, via the relay, the header decompression information to a terminal accessing the relay, and
the terminal decompresses the compressed GTP header using the header decompression information.

4. The base station of claim 3, wherein:
the receiver additionally receives, from the gateway, a User Datagram Protocol (UDP) header associated with the GTP header and an Internet Protocol (IP) header associated with the GTP header,
the header compression unit compresses the UDP header associated with the GTP header and the IP header associated with the GTP header, and
the transmitter transmits the compressed UDP header and IP header to the terminal via the relay.

5. The base station of claim 4, wherein:
the header compression unit generates, as the header decompression information, information to decompress the UDP header associated with the GTP header, and information to decompress the IP header associated with the GTP header,
the transmitter transmits the header decompression information to the terminal, and
the terminal decompresses the compressed UDP header and IP header, using the header decompression information.

6. The base station of claim 1, further comprising:
a Stream Control Transport Protocol (SCTP) header generation unit, wherein the receiver receives a plurality of data packets,
the SCTP header generation unit generates, as an SCTP header, information associated with the plurality of data packets, and
the transmitter transmits the SCTP header and the plurality of data packets to the relay.

7. A relay comprising:
a receiver to receive a data packet and a compressed GTP header from a base station;
a header decompression unit to decompress the compressed GTP header; and
a transmitter to transmit the data packet to a terminal using the decompressed GTP header.

8. The relay of claim 7, wherein the header decompression unit decompresses the compressed GTP using a ROHC scheme.

9. The relay of claim 7, wherein:
the receiver receives header decompression information from the base station, and
the header decompression unit decompresses the compressed GTP header using the header decompression information.

10. The relay of claim 7, wherein:
the receiver additionally receives a compressed UDP header associated with the compressed GTP header and a compressed IP header associated with the compressed GTP header,
the header decompression unit decompresses the compressed UDP header and IP header, and
the transmitter transmits the data packet to the terminal using the decompressed UDP header and IP header.

11. A gateway comprising:
a header compression unit to compress an IP header associated with data and a UDP/Real-time Transport Protocol (RTP) header associated with the data; and
a transmitter to transmit the data, the compressed IP header, and the compressed UDP/RTP header to a base station,
wherein the base station forwards the data, the compressed IP header, and the compressed UDP/RTP header to a relay.

12. The gateway of claim 11, wherein the header compression unit compresses the IP header or the UDP/RTP header using a ROHC scheme.

13. The gateway of claim 11, wherein:
the header compression unit generates header decompression information to decompress the IP header associated with the data or the UDP/RTP header associated with the data,
the transmitter transmits the header decompression information to a terminal accessing the relay, via the base station and the relay accessing the base station, and
the terminal decompresses the IP header or the UDP/RTP header using the header decompression information.
